(19) United States
(12) Patent Application Publication
(10) Pub. No.: US 2002/0144771 A1
(43) Pub. Date: Oct. 10, 2002

(54) UV curable adhesives containing ceramic microspheres

(76) Inventor: Joseph Paul Kuczynski, Rochester, MN (US)

Correspondence Address: Matthew J. Bussan, Attorney At Law, 8564 Mathes Drive, West Chester, OH, 45069, US

(21) Appl. No.: 10/090,214

(22) Filed: Mar. 4, 2002

Related U.S. Application Data
(62) Division of application No. 09/248,285, filed on Feb. 11, 1999.

(51) Int. Cl. B32B 31/00

(52) U.S. Cl. 156/272.2; 156/307.1; 156/329

(57) ABSTRACT

A photocurable adhesive composition is disclosed which includes a photocurable adhesive and an effective amount of a ceramic-containing modifier which does not substantially reduce a photocure rate of the photocurable adhesive. The modifier alters the flow properties of the composition to facilitate controlled dispensing of the uncured adhesive composition. The modifier alters the thermal expansion properties of the cured composition to reduce bondline stress. The preferred modifier includes inert, alkali alumino-silicate microspheres. A method of adhesive bonding is also disclosed in which an adherend is adhered to a substrate using a photocurable adhesive composition containing a photocurable adhesive and microspheres.

### REFERENCE TO PARENT APPLICATION

This application is a divisional of U.S. Ser. No. 09/248,285, filed on Feb. 11, 1999 by Joseph Paul Kuczynski, entitled “UV Curable Adhesives Containing Ceramic Microsheres”, which is hereby incorporated by reference.

### BACKGROUND OF THE INVENTION

1. Field of the Invention

The invention relates to the field of photocurable adhesive bonding. Specifically, the invention relates to adhesive bonding of optical sub-assemblies, for example, to substrates using a pseudoplastic ultraviolet radiation curable adhesive composition containing ceramic microspheres.

2. Background Information

During the fabrication of numerous electronic and electro-optic devices, such as optical sub-assemblies, adhesives are often utilized to fasten components together. The adhesives may be broadly divided into two major classes: heat curable and ultraviolet (UV) curable adhesives. UV curable adhesives offer distinct process time enhancements compared to typical heat curable adhesives. For example, the cycle time for the manufacture of optical sub-assemblies (OSAs) can be reduced 40-50% via implementation of a UV curable adhesive as compared to a heat curable adhesive.

Production of tight tolerance parts, such as electronic and electro-optical devices bonded to substrates, often places rigid demands on the adhesive, particularly with respect to deformation and flow, i.e., rheology, control. The flow properties of the material should be tailored to ensure that the adhesive is pseudoplastic and non-sagging. As is well known, the viscosity of pseudoplastic materials decreases as the shear force on them increases. It is also important that the adhesive remain at the location where it is dispensed and not “run” along the substrate or part to be bonded prior to cure. Additionally, the thermal coefficient of expansion (TCE) must oftentimes be minimized to reduce thermally-induced stress at the bond line.

One common method of providing adequate rheology and TCE control is to load UV curable adhesives with an inert filler. The most commonly employed filler is fused silica. Unfortunately, the loadings required to achieve the desired flow properties, typically greater than 50 wt. %, adversely reduce the photospeed of the photocurable adhesive. Photospeed is a measure of the rate at which a photocurable adhesive cures. Although the slow photospeed problem has been previously identified, it has oftentimes been tolerated in the art.

### SUMMARY OF THE INVENTION

It is, therefore, a principle object of the invention to provide an ultraviolet curable adhesive composition containing ceramic microspheres, and a related bonding method and laminate formed thereby.

It is another object of the invention to provide an ultraviolet curable adhesive composition and a related bonding method and laminate formed thereby that solve the above-mentioned problems related to photospeed.

These and other objects of the present invention are accomplished by the ultraviolet curable adhesive composition containing ceramic microspheres and a related bonding method and laminate formed thereby disclosed herein.

According to one aspect of the invention, an ultraviolet curable adhesive composition containing ceramic microspheres is provided. Unlike traditional photocurable adhesive rheology-modifying fillers, such as fused silica, the ceramic microspheres used in combination with a photocurable adhesive do not substantially reduce the photocure rate of the preferred ultraviolet curable adhesives. The cure speed of the UV curable adhesives is essentially unaffected even at high microsphere loadings.

Another aspect of the invention relates to a method of adhesively bonding together an adherend to a substrate using a photocurable adhesive composition containing a ceramic-containing rheology modifier that allows for faster photospeeds than previously possible using known photocurable adhesive rheology modifiers.

Yet another aspect of the invention relates to a laminate formed by an adherend and substrate bonded together by a photocured adhesive composition containing ceramic microspheres. Preferably, the adherend is an electronic or electro-optical device, such as an optical sub-assembly, bonded to a circuit board substrate using a photocurable adhesive containing ceramic microspheres.

These and other aspects of the invention will become apparent from the detailed discussion set forth below.

### BRIEF DESCRIPTION OF DRAWINGS

FIG. 1 is a perspective view of an adherend, substrate, and microsphere-laden adhesive composition.

FIG. 2 is a side view of a laminate being formed with the microsphere-laden adhesive composition photocured using a UV light source.

FIG. 3 is a photodifferential scanning calorimetric trace of the curing of an adhesive composition according to one aspect of the invention.

### DETAILED DESCRIPTION OF THE PREFERRED EMBODIMENT(S)

The invention will now be described in more detail by way of example with reference to the embodiment(s) shown in the accompanying figures. It should be kept in mind that the following described embodiment(s) is/are only presented by way of example and should not be construed as limiting the inventive concept to any particular physical configuration.

One aspect of the invention relates to an adhesive composition of matter including a photocurable adhesive and microspheres. Upon exposure to an effective amount of light energy, the photocurable adhesive cures to a hardened state. Photocurable adhesives are preferred over thermal cure systems because they cure much faster than heat curable adhesives. The microspheres advantageously modify the rheological and thermal expansion properties of the adhesive composition. Specifically, an effective amount of microspheres combined with the adhesive to form the composition enhances its pseudoplastic and non-sagging flow properties while decreasing the coefficient of thermal expansion of the adhesive composition. Pseudoplastic flow is desired for good flow control of the adhesive composition during and after dispensing onto the part or substrate to be bonded. Reduced thermal expansion is desired to reduce stress at the bond line between the bonded parts once the adhesive has cured.

Surprisingly, the use of microspheres as the Theological and thermal property modifier allows for much faster light curing (“photospeed”) than was possible in the past using UV curable adhesives containing fused silica modifiers, for example. Incorporation of microspheres into the UV curable adhesive imparts the desired flow and thermal expansion properties without substantially reducing the photospeed. The composition allows for faster photospeeds than previously possible using known rheology and thermal expansion modifiers used previously in photocurable adhesives.

The photocurable adhesive can be any adhesive that cures to a sufficiently hardened state to hold a part, such as an electronic or electro-optical component, to a substrate upon exposure to an effective amount of light energy. The light energy can be visible light, ultraviolet light, electron beams, or other forms of actinic radiation. “Actinic radiation” refers to electromagnetic radiation that effects chemical changes in certain materials, such as the photocurable adhesives disclosed here. Preferably, the photocurable adhesive is a UV radiation curable adhesive. It is believed that any UV curable adhesive would be suitable for use in practicing the invention. Suitable UV curable adhesives include, for example, silicones, acrylated urethanes, vinyl ethers, acrylates, methacrylates, and epoxy-based systems, such as acrylated epoxies.

A preferred adhesive is a UV radiation- and thermally-curable urethane acrylate adhesive, such as Dymax 6-628 gel adhesive available from Dymax Corporation, Torrington, Conn., USA. Table 1 tabulates the composition of the 6-628 gel based on information provided by Dymax Corporation.

TABLE 1
Composition of Dymax Corporation 6-628 Gel Adhesive

| Component | Amount, wt. % |
|---|---|
| high boiling methacrylate | 20-70 |
| polyurethane oligomer | 10-20 |
| acrylic impact modifier | 10-20 |
| acrylic acid | 1-5 |
| silica, amorphous, fumed | 1-5 |
| maleic acid | 1-4 |
| α,α-dimethoxy-α-phenylacetophenone | 1-4 |
| t-butyl peroxybenzoate | 1-4 |

The microspheres may be combined with the adhesive to modify the rheological properties and reduce the TCE of the adhesive. The pseudoplastic flow properties of the microsphere-filled adhesive were investigated as follows. The Dymax 6-628 gel adhesive and two other UV curable adhesives, Dymax 9001 and Dymax 9001 v. 3.1, were filled with about 60 wt. % Zeeospheres® brand microspheres (grade W-210, described below). Pseudoplastic flow behavior of the adhesive was evaluated by dispensing a dollop of adhesive on a glass slide, holding the slide vertically for 60 sec, curing the material with a 90 J/cm² dose of radiation, and measuring the distance that the adhesive flowed. Dosing was accomplished by exposing the adhesive for 20 sec to an incident flux of radiant energy per unit area of 4500 mW/cm² from a UV light source. The flow distance is considered a measure of the tendency of the material to sag. Table 2 tabulates the results for the three UV curable adhesives that were tested.

TABLE 2
Effect of Microspheres on Flow of Adhesive

| | Flow Distance, mm | |
|---|---|---|
| Adhesive | No Added Microspheres | Microspheres-Filled |
| Dymax 9001 | 4 | 0 |
| Dymax 9001 v. 3.1 | 7 | 0.5 |
| Dymax 6-628 gel | 1 | 0 |

The flow data reported in Table 2 show that filling a UV curable adhesive with microspheres significantly reduces the tendency of the uncured adhesive to sag. This property of the microsphere-filled adhesive is very beneficial because accurate dispensing of the uncured adhesive is crucial in the manufacture of optical sub-assemblies. Among the adhesives tested with no added microspheres, the 6-628 gel exhibits the least sag behavior apparently because it includes 1-5% silica flow modifier. The 9001 adhesive does not appear to contain any silica filler. The 9001 v. 3.1 adhesive contains about 4.9 wt. % inert filler, but it is unclear whether any of this filler is silica.

In view of the beneficial modification of the adhesive flow properties, the microspheres are preferably combined with the adhesive before the adhesive is applied to either the part or substrate. The microspheres advantageously increase the pseudoplasticity of the adhesive and thereby reduce the tendency of the adhesive to sag. This modification of the rheological or “flow” properties of the adhesive facilitates controlled dispensing of the desired quantity of the adhesive only to those regions of the part and/or substrate where the adhesive is desired. Once the microsphere-laden adhesive is applied to a part or substrate, the adhesive composition tends to remain in place without “running.”

A wide variety of UV light sources that can be used in practicing this invention are commercially available. Preferably, the UV radiation is unfiltered from a mercury arc lamp. The spectral output from a mercury arc lamp is most intense at the wavelengths 313 nm and 365 nm. One suitable UV source is a Novacure® brand UV spot curing source available from EFOS USA Inc., Williamsville, N.Y., USA. The irradiance of the unit was about 4500 mW/cm². The adhesive may be irradiated with the desired dose of light energy preferably by controlling the time the adhesive is exposed to the radiation source. The skilled artisan will recognize that the light source and type of photocurable adhesive should each be selected with the other in mind. Many photocurable adhesives cure faster in UV light than in visible light. Accordingly, a UV light source should be selected for such a UV curable adhesive.

The effect of the microspheres on the TCE of the UV cured Dymax 6-628 gel adhesive is shown in Table 3. TCE data are reported as volume parts per million per degree at temperatures below and above the glass transition temperature, Tg, of the material.

TABLE 3
TCE Results for Filled and Unfilled Adhesive*

| | Thermal Coefficient of Expansion, ppm/° C. | | |
|---|---|---|---|
| | Unfilled | Filled (60 wt. %) | % Reduction |
| T < T_{g} | 65.6 | 21.8 | 67% |
| T > T_{g} | 440.6 | 288.3 | 35% |

* Dymax 6-628 gel adhesive

The results reported in Table 3 show that filling the Dymax 6-628 gel with about 60 wt. % microspheres reduces the TCE of the cured material below its glass transition temperature by about 67%. The results also show that when the same material is above its glass transition temperature, filling with about 60 wt. % microspheres reduces the TCE by about 35%. The data show that filling a UV curable adhesive with an effective amount of microspheres produces a significant beneficial decrease in the TCE of the cured adhesive.

The bond strength of the cured microspheres-filled adhesive is also very good. Microspheres-filled adhesive was dispensed around the periphery of a laser/receiver and cured using the Novacure® spot curing source described above. The irradiance was 4500 mW/cm². The incident dose of radiation was 90 J/cm². Bond strength was tested using an Instron 4505 unit. The average pull strength of three tests was 14.6±3.5 lbs.

The microspheres can be made from a wide variety of materials, such as inert ceramic, glass, and plastic. Glass and plastic may, however, filter out too much of the UV radiation from a preferred source, a mercury arc lamp, thereby reducing photospeed. Also, compared to ceramic materials, glass and plastic have relatively higher thermal coefficients of expansion. Accordingly, the microspheres are preferably made from a ceramic material, such as inert alkali alumino-silicates. The microspheres are preferably solid substantially throughout their volume, but hollow microspheres may also be used. Hollow microspheres are described, for example, in U.S. Pat. No. 4,504,565 to Baldvins et al.

An especially preferred ceramic microsphere product which can be used in accordance with the present invention is commercially available from Zeelan Industries, Inc., a wholly-owned subsidiary of 3M Company, located in Minneapolis, Minn., USA, under the trade name ZEEOSPHERES®. The inert, ceramic ZEEOSPHERES are preferably generally white in color. Gray microspheres can also be used, but photospeed is slightly decreased compared to the white microsphere. The ZEEOSPHERES brand of white ceramic microspheres is available in three grades, designated W-610, W410, and W-210. Table 4 tabulates information provided by 3M Corporation on the particle size distribution of the three grades.

TABLE 4
Particle Size Distribution of ZEEOSPHERES
Brand White Ceramic Microspheres

Particle Size, μm

| | Distribution, percentile by volume | | | Effective |
|---|---|---|---|---|
| Grade | 10^{th} % | 50^{th} % | 90^{th} % | Maximum Size |
| W-210 | 1 | 3 | 11 | 12 |
| W-410 | 1 | 4 | 15 | 24 |
| W-610 | 1 | 10 | 28 | 40 |

It is expected that any of the three grades will work satisfactorily. The smallest particle size grade, W-210, is preferred in order to maximize the loading level and thereby minimize the TCE.

The microspheres are preferably generally spherical in shape. Unlike irregularly shaped particles, spherical particles easily roll over one another. Therefore, it is possible to decrease viscosity, control rheology, and still maintain the adequate flow necessary for adhesive dispensing at the loading levels required for the desired reduction in the TCE.

The microspheres and adhesive may be combined using any known manner to substantially uniformly disperse the microspheres throughout the adhesive. Preferably, the microspheres and adhesive are combined before the composition is applied to the adherend, the substrate, or both. The microspheres and adhesive may be combined, for example, by a conventional moving impeller-type mixing apparatus, a static in-line mixer, or any other known mixer apparatus.

The preferred microsphere loading level in the adhesive to achieve the desired combination of rheology and TCE control is dependent on the initial viscosity of the base adhesive as well as the size of the microspheres. The final viscosity of the microsphere-filled adhesive should range from about 60,000 cP to about 150,000 cP or more. Using microspheres approximately the size of the W-210 grade and the Dymax 6-628 gel adhesive described above, the preferred loading level is from about 35 wt. % to about 75 wt. %. Most preferably, the loading level for this particular adhesive is about 60 wt. %. The desired flow and TCE properties are not ordinarily sufficiently realized at loading levels less then about 35 wt. % for the Dymax 6-628 gel adhesive system. Loadings higher than about 75 wt. % tend to render this adhesive difficult to dispense due to excessively high viscosity. Above this loading level, bond strength is also reduced apparently due to failure of this adhesive to adequately wet the bonding surfaces. In light of this disclosure, the skilled artisan will be able to determine the preferred microsphere loading level for different adhesives and other microsphere size grades without undue experimentation.

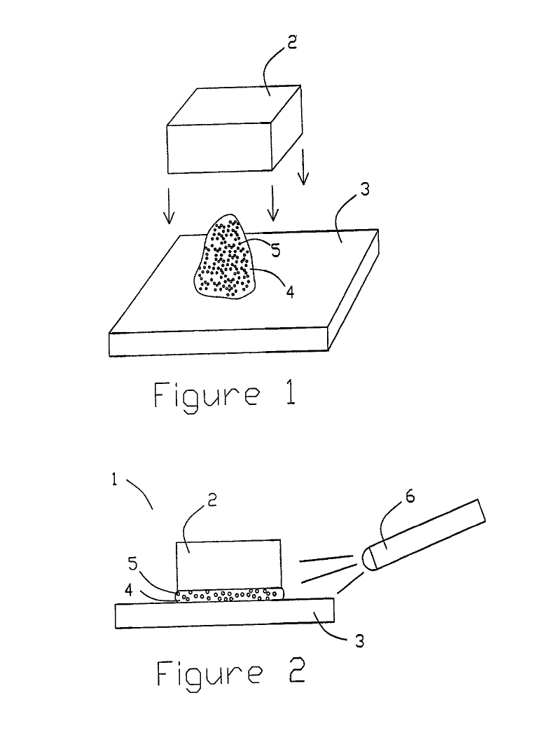

As shown in FIG. 1 and FIG. 2, another aspect of the invention relates to a method of adhesively bonding together an adherend 2 to a substrate 3 using a photocurable adhesive composition containing adhesive 4 and microspheres 5. The drawings are not to scale. The size of the microspheres has been enlarged for clarity. FIG. 2 shows a light source 6 that can be used to expose the adhesive composition to sufficient light energy to photocure the adhesive. The photocurable adhesive may be exposed to a dose of 40-120 J/cm² or more, preferably 90-110 J/cm², of actinic radiation, such as ultraviolet light.

The skilled artisan will know how to clean or otherwise prepare the adherend and substrate surfaces for photocured adhesive bonding. The adhesive composition containing the modifier may be applied to the adherend, the substrate, or both using any known technique or device for dispensing materials having similar rheological properties. For example, the adhesive composition may be extruded from a nozzle by suitable dispensing means not forming a part of this invention. The devices currently in use for dispensing fused silica-laden photocurable adhesives would be suitable. Preferably, the photocurable adhesive is protected from exposure to photocuring radiation while stored in the dispensing apparatus to prevent premature photocuring of the adhesive composition.

After the modifier-laden photocurable adhesive composition has been placed between and in contact with the adherend and substrate, the adherend and substrate are gently but firmly pressed together. The adhesive composition may then be photocured by exposure to a sufficient intensity of curing radiation for a sufficient period of time to effect curing, i.e., hardening, of the adhesive composition and adhesive bonding of the adherend and substrate. Several examples of photocuring are set forth below. If desired, laminating pressure may be maintained until after the adhesive has photocured.

In order to assess the photospeed performance of a microsphere-laden UV curable adhesive composition according to the invention, several exemplary and comparative formulations were prepared and cured. Comparative examples A-D did not contain any modifier. Comparative examples E-H contained 62.56 wt. % fused silica. Comparative examples I-L contained 64.11 wt. % fused silica. Examples 1-4 contained 62.78 wt. % W-210 grade white ZEEOSPHERES® ceramic microspheres as the modifier. In each case, the adhesive was the Dymax 6-628 gel adhesive described above. The UV radiation source was a Novacure® spot curing unit which developed an irradiance, i.e., an incident radiant energy flux per unit area, of 4500 mW/cm². Samples of each adhesive were dispensed onto a circular plastic assembly to approximately the same height and width, fixtured within the interior of a 10 mm inner diameter light ring, and subjected to various UV radiation doses as tabulated below. The dose was varied by adjusting the time of exposure to the UV source. For example, doses of 45 J/cm², 67 J/cm², 90 J/cm², and 112 J/cm² resulted from exposure times of 10 sec, 15 sec, 20 sec, and 25 sec, respectively. Following exposure, samples of each cured adhesive composition were excised from the plastic assembly and subjected to thermal analysis via differential scanning calorimetry (DSC) to determine the extent of cure. Filler content was determined via thermogravimetric analytic (TGA) pyrolysis. The results are tabulated below in Table 5.

TABLE 5
Photospeed Evaluations

| Examples | Dose, J/cm² | % Cure |
|---|---|---|
| Unfilled Adhesive: | | |
| Comparative A | 45 | 90.4 +/− 0.85 |
| Comparative B | 67 | 93.3 +/− 0.42 |
| Comparative C | 90 | 93.2 +/− 0.84 |
| Comparative D | 112 | 95.1 +/− 0.50 |
| Silica-filled Adhesive¹ | | |
| Comparative E | 45 | 76.1 +/− 2.72 |
| Comparative F | 67 | 86.1 +/− 4.24 |
| Comparative G | 90 | 93.3 +/− 0.58 |
| Comparative H | 112 | 94.1 +/− 0.92 |
| Silica-filled Adhesive² | | |
| Comparative I | 45 | 78.2 +/− 1.72 |
| Comparative J | 67 | 81.7 +/− 2.09 |
| Comparative K | 90 | 85.0 +/− 0.82 |
| Comparative L | 112 | 90.5 +/− 1.36 |
| Microsphere-filled Adhesive³ | | |
| Example 1 | 45 | 90.3 +/− 4.0 |
| Example 2 | 67 | 90.9 +/− 2.4 |
| Example 3 | 90 | 91.0 +/− 1.8 |
| Example 4 | 112 | 96.2 +/− 2.7 |

¹62.56 wt. % filler
²64.11 wt. % filler
³62.78 wt. % filler

As shown in Table 5, compared to the unfilled adhesive formulation, the silica-filled formulations result in a substantial reduction in the degree of cure at the lower dose exposures. Even at the highest UV dose, the silica-filled formulations were less fully cured than the unfilled adhesive formulation. In sharp contrast, the degree of cure is essentially unaffected by the ceramic microsphere filler. Even at the lowest UV dose, the microsphere-filled adhesive formulation was over 90% cured. At the highest UV dose, cure had progressed to over 96%.

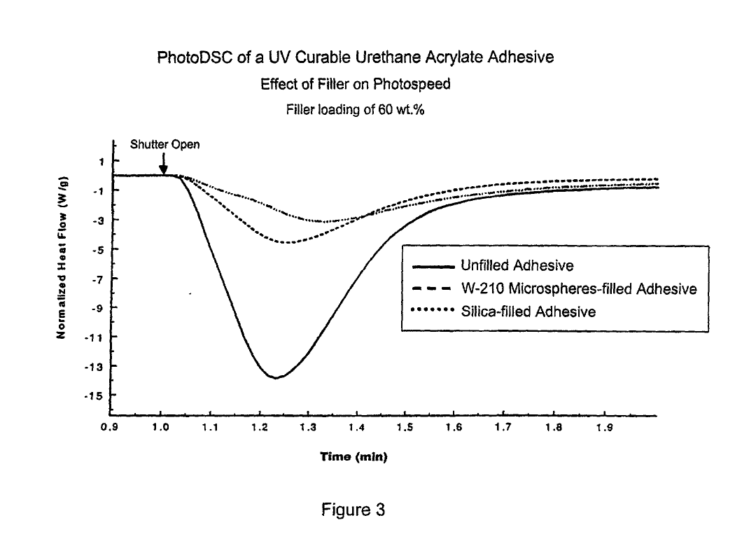

Photodifferential scanning calorimetry analysis was also performed on the unfilled adhesive, silica-filled adhesive, and microsphere-modified adhesive. Each adhesive formulation was filled to 60 wt. % filler. The adhesive was a UV curable urethane acrylate. The results depicted in FIG. 3 show that the time to reach peak exotherm was essentially identical for both the unfilled adhesive (approximately 1.233 min) and the microsphere-modified adhesive (approximately 1.250 min). In contrast, the time to reach peak exotherm for the silica-filled adhesive, was about 1.333 min, or, about 8% longer than for the unfilled adhesive.

Yet another aspect of the invention relates to laminates made using the microsphere-modified adhesive composition and adhesive bonding process described above. As shown in FIG. 2, the laminate 1 includes an adherend 2 and substrate 3 bonded together by the photocured adhesive composition containing adhesive 4 and microspheres 5.

The adherend, or part to be bonded to the substrate, can be virtually any object for which adhesion to a substrate is desired. The adherend may be, for example, an electronic or electro-optical element. More specifically, the adherend may be a semiconductor chip, charged couple device (CCD), light emitting diode (LED), or an optical sub-assembly (OSA). As used in information systems, optical fibers are usually connected between optical sub-assemblies which either transmit or receive optical signals. Examples of various means for providing connections between optical fibers and electronic circuitry are illustrated in U.S. Pat. No. 4,273,413 (Bendiksen et al), U.S. Pat. No. 4,547,039 (Caron et al), U.S. Pat. No. 4,647,148 (Katagiri), U.S. Pat. No. 4,707,067 (Haberland et al.) and U.S. Pat. No. 5,005,939 (Arvanitakis et al.). Preferably, the adherend is a receiving optical sub-assembly (ROSA) or transmitting optical sub-assembly (TOSA).

The substrate may be virtually any object having a surface to which the adhesion of the adherend may be desired. For example, the substrate may be a circuit board, especially one designed for holding a number of electronic or electro-optical elements. The adherends may, for example, be soldered or otherwise electrically connected to electrical pads and traces on the substrate, if desired, using methods and materials generally known to those skilled in the art. Most preferably, the substrate is a printed circuit board.

The faster photospeed of the microsphere-filled UV curable adhesive composition according to the invention as compared to the silica-filled UV curable adhesive system can translate into a 16% reduction in optical sub-assembly fabrication cycle time. Accordingly, fabrication process productivity is significantly higher using a microsphere-filled UV curable adhesive composition rather than a silica-filled UV curable adhesive.

It will be apparent to one skilled in the art that the manner of making and using the claimed invention has been adequately disclosed in the above-written description of the preferred embodiment(s) taken together with the drawings.

It will be understood that the above described preferred embodiment(s) of the present invention are susceptible to various modifications, changes, and adaptations, and the same are intended to be comprehended within the meaning and range of equivalents of the appended claims.

Further, although a number of equivalent components may have been mentioned herein which could be used in place of the components illustrated and described with reference to the preferred embodiment(s), this is not meant to be an exhaustive treatment of all the possible equivalents, nor to limit the invention defined by the claims to any particular equivalent or combination thereof. A person skilled in the art would realize that there may be other equivalent components presently known, or to be developed, which could be used within the spirit and scope of the invention defined by the claims.

I claim:

1. A method of adhesive bonding comprising:
providing an adherend;
providing a substrate;
providing a photocurable adhesive;
contacting said adherend and said substrate with said photocurable adhesive composition containing an adhesive and an effective amount of microspheres; and
photocuring said adhesive composition to form an at least partially cured adhesive composition whereby said adherend and substrate are bonded together.

2. The method of claim 1 wherein said photocuring includes exposing said adhesive composition to an effective dose of ultraviolet radiation for a predetermined time.

3. The method of claim 2 wherein said dose is 40-120 J/cm².

4. The method of claim 3 wherein said dose is 90-110 J/cm².

5. The method of claim 1 wherein said at least partially cured adhesive composition is at least 90% fully cured.

6. The method of claim 5 wherein said at least partially cured adhesive composition is at least 95% fully cured.

7. The method of claim 1 wherein said microspheres are made of a ceramic material.

8. The method of claim 7 wherein said microspheres are solid substantially throughout their volume.

9. The method of claim 8 wherein the diameters of said microspheres are about 40 microns or less.

10. The method of claim 1 wherein said effective amount is about 35-75 wt. % of said adhesive composition.

11. The method of claim 10 wherein said effective amount is about 60-65 wt. % of said adhesive composition.

12. The method of claim 1 wherein said microspheres are made from silicate.

13. The method of claim 12 wherein said silicate is an alumino-silicate.

14. The method of claim 13 wherein said alumino-silicate is an alkali alumino-silicate.

15. The method of claim 1 wherein the adhesive composition is a pseudoplastic material.

16. The method of claim 1 wherein the thermal coefficient of expansion of the adhesive composition in the photocured state is less than that of said adhesive in the photocured state.
